(19) United States
(12) Patent Application Publication
(10) Pub. No.: US 2004/0085959 A1
(43) Pub. Date: May 6, 2004

(54) Data transmission method

(76) Inventor: Yasuhito Ohkawa, Otsu (JP)

Correspondence Address: WENDEROTH, LIND & PONACK, L.L.P., 2033 K STREET N. W., SUITE 800, WASHINGTON, DC, 20006-1021, US

(21) Appl. No.: 10/431,524

(22) Filed: May 8, 2003

(30) Foreign Application Priority Data
May 10, 2002 (JP) 2002-135942

(51) Int. Cl. H04L 12/56

(52) U.S. Cl. 370/389; 370/252

(57) ABSTRACT

A bandwidth adjusting access point 10 allocates a bandwidth to transfer data input via the internet 1000 and transfers the transfer data to information processing apparatuses 1020₁ to 1020₄. When new transfer data is input to the bandwidth adjusting access point 10, the bandwidth adjusting access point 10 determines whether the new transfer data can be transferred by comparing its own available bandwidth with a required bandwidth, which is set in the new transfer data by servers 15₁ to 15₄ and indicates a bandwidth required for transfer. When the new data cannot be transferred, the bandwidth adjusting access point 10 reduces a bandwidth of transfer data which is being transferred, based on a priority and a media type, which are embedded in the new transfer data, so a store serve a bandwidth for the new transfer data. Thus, even when a bandwidth of a LAN system becomes congested, a transfer rate for transfer data, which requires a broad bandwidth, is guaranteed.

### BACKGROUND OF THE INVENTION

1. Field of the Invention

The present invention relates to an access point, and more particularly to an access point for use in a radio LAN system in which data is exchanged between the access point and one or more information processing apparatuses by radio.

2. Description of the Background Art

In recent years, with the spread of information processing apparatuses, such as computers, and the advance of radio communication technologies, radio LANs have become constructed and have come into common use for transmitting/receiving data by radio between radio communication terminals each including an information processing apparatus, such as a computer, and a radio communication adaptor connected thereto.

FIG. 29 is a block diagram illustrating a configuration of a typical LAN system. This LAN system includes a router 1005, an access point 1010, radio communication adaptors 1015₁ to 1015₄, and information processing apparatuses 1020₁ to 1020₄.

The router 1005, which is connected to the access point 1010 and the internet 1000, has a routing function. The access point 1010 has a function of communicating with each of the radio communication adaptors 1015₁ to 1015₄ by radio. Each of the information processing apparatuses 1020₁ to 1020₄ is connected to a corresponding one of the radio communication adaptors 1015₁ to 1015₄.

An operation of the thus-configured LAN system will be described below. Specifically, the following description relates to the operation performed by the LAN system when each of the information processing apparatuses 1020₁ to 1020₄ acquires transfer data transmitted via the internet.

Processing is started when the transfer data is input to the router 1005 via the internet 1000.

The router 1005 having acquired the transfer data refers to an IP address of the acquired transfer data, and determines whether to pass the transfer data therethrough. The transfer data having been determined to be passed through is output to the access point 1010. On the other hand, the transfer data having been determined not to be passed through is discarded by the router 1005.

The access point 1010 having acquired the transfer data transfers the transfer data to each of the radio communication adaptors 1015₁ to 1015₄ in a broadcasting format. Each of the radio communication adaptors 1015₁ to 1015₄ outputs the acquired transfer data to a corresponding one of the information apparatuses 1020₁ to 1020₄ connected thereto. Each of the information processing apparatuses 1020₁ to 1020₄ having acquired the transfer data refers to a MAC address of the transfer data, and determines whether the transfer data is destined therefor. The information processing apparatuses 1020₁ to 1020₄ for which the acquired transfer data is destined store the acquired transfer data therein. On the other hand, the information processing apparatuses 1020₁ to 1020₄ for which the acquired transfer data is not destined discard the acquired transfer data. In this manner, the transfer data appropriately reaches the information processing apparatuses 1020₁ to 1020₄.

In the above-described conventional LAN system, when the access point 1010 simultaneously exchanges the transfer data with the plurality of information processing apparatuses 1020₁ to 1020₄ via the radio adaptors 1015₁ to 1015₄, the access point 1010 allocates a bandwidth to be used, for each transfer data. Thus, the access point 1010 can transfer a plurality of transfer data to the plurality of information processing apparatuses 1020₁ to 1020₄ via the radio adaptors 1015₁ to 1015₄.

Examples of the transfer data to be transferred by the access point 1010 include streaming-based video data, which requires a high-speed transfer rate, text data, which requires only a low-speed transfer rate, etc. As such, the size of a bandwidth required for data transfer varies depending on types of the transfer data, etc. However, the access point 1010 of the conventional LAN system allocates the same sized bandwidth to each transfer data. As a result, when the bandwidth of the access point 1010 becomes congested, a bandwidth to be allocated to each transfer data becomes small. Therefore, the streaming-based video data, which requires a high-speed transfer rate, is prevented from being reproduced in stream.

### SUMMARY OF THE INVENTION

Therefore, an object of the present invention is to provide a LAN system capable of guaranteeing a sufficient transfer rate for transfer data, which requires a broad bandwidth, even when the bandwidth of an access point becomes congested.

The present invention has the following features to attain the object mentioned above.

A first aspect of the present invention is directed to a data transmission method for transmitting data from a data transmitter to a LAN system, the data transmitter being connected to the LAN system via a network so as to be allowed to intercommunicate therewith, the method comprising: an information embedding step for embedding required bandwidth information into the data when the LAN system requests the data transmitter to transmit the data, the required bandwidth information being specific to the data and indicating a bandwidth required for transferring the data; and a data transmission step for transmitting the data having the required bandwidth information embedded therein to the LAN system via the network, wherein the LAN system performs a data-by-data determination as to whether bandwidths internally available can be used based on the required bandwidth information embedded in received data.

In the first aspect, the data transmitter transmits a required bandwidth embedded in data to the LAN system, and therefore the radio LAN system can determine whether to transfer the data based on the required bandwidth. Thus, a transfer rate of data being transferred is prevented from being lowered by new data, which is transmitted to the LAN system and consumes a bandwidth thereof, when the bandwidth of the LAN system becomes congested, thereby preventing streaming reproduction of video data from being interrupted.

According to a second aspect based on the first aspect, the data transmission method further comprises: a data receiving step for the LAN system to receive the data transmitted by the data transmission step; a bandwidth recognition step for recognizing the bandwidth required for transferring the data based on the required bandwidth information embedded in the data received by the data receiving step; an occupied bandwidth recognition step for recognizing a bandwidth currently being used among the bandwidths internally available; and a determination step for determining whether sufficient bandwidth is available to the data received by the data receiving step by comparing the bandwidth required for transferring the data, which is recognized by the bandwidth recognition step, and the bandwidth currently being used, which is recognized by the occupied bandwidth recognition step.

In the second aspect, the LAN system determines whether to transfer data by comparing a bandwidth required for data transfer and a bandwidth currently being used, and therefore when an available bandwidth of the LAN system is too narrow to transfer the data, the data is not transferred. Thus, undesirable data transfer is prevented, thereby effectively utilizing the bandwidth of the LAN system.

According to a third aspect based on the first aspect, the information embedding step embeds priority information, which indicates a priority for allowing the data to use the bandwidths internally available, into the data as well as the required bandwidth information; and the LAN system performs the data-by-data determination as to whether the bandwidths internally available can be used based on the required bandwidth information and the priority information.

In the third aspect, the data transmitter transmits to the LAN system priority information embedded in data as well as the required bandwidth information, and therefore the LAN system can determine whether to transfer the data based on these pieces of information. Thus, the LAN system can determine which data to be transferred or which data not to be transferred by comparing priorities of data being transferred, for example.

According to a fourth aspect based on the third aspect, the data transmission method further comprises: a data receiving step for the LAN system to receive the data transmitted by the data transmission step; a bandwidth recognition step for recognizing the bandwidth required for transferring the data based on the required bandwidth information embedded in the data received by the data receiving step; an occupied bandwidth recognition step for recognizing a bandwidth currently being used among the bandwidths internally available; a priority recognition step for recognizing data-by-data priorities based on the priority information embedded in the data; a determination step for determining whether sufficient bandwidth is available to the data received by the data receiving step by comparing the bandwidth required for transferring the data, which is recognized by the bandwidth recognition step, and the bandwidth currently being used, which is recognized by the occupied bandwidth recognition step; and a bandwidth adjusting step for reducing a bandwidth of data, which has a priority lower than that of the data received by the data receiving step among the data-by-data priorities recognized by the priority recognition step, so as to allow the sufficient bandwidth to be available to the data received by the data receiving step when the determination step determines that no sufficient bandwidth is available.

In the fourth aspect, the LAN system reduces a bandwidth of data, which is being transferred and has a priority lower than that of the data received by the data receiving step, thereby allowing the data received by the data receiving step to use the bandwidth of the LAN system. Thus, it is possible to reserve a bandwidth for highly urgent data having a high priority.

According to a fifth aspect based on the fourth aspect, the LAN system has a minimum guaranteed bandwidth stored therein, the minimum guaranteed bandwidth indicating minimum bandwidths required for data transfer on a media-type-by-media-type basis of the data; the information embedding step embeds media type information, which indicates a media type of the data, as well as the required bandwidth information and the priority information; the priority recognition step further includes a media type recognition step for recognizing a data-by-data media type based on the media type information embedded in the data; and the bandwidth adjusting step refers to the minimum guaranteed bandwidth stored in the LAN system and reduces the bandwidth of the data to the minimum guaranteed bandwidth corresponding to a media type recognized by the media type recognition step.

In the fifth aspect, when the LAN system reduces a data bandwidth, the bandwidth is reduced to the minimum guaranteed bandwidth. Thus, a minimum possible transfer rate is guaranteed even to the data having the reduced bandwidth.

According to a sixth aspect based on the fifth aspect, the bandwidth adjusting step sequentially reduces a data bandwidth from the lowest to the highest in the order of minimum guaranteed bandwidths.

In the sixth aspect, the data bandwidth is sequentially reduced from the lowest to the highest in the order of the minimum guaranteed bandwidths, and therefore the likelihood of reduction in bandwidth of data having a high minimum guaranteed bandwidth is lessened. A conceivable general example of such data having a low minimum guaranteed bandwidth is text data, and a conceivable general example of such data having a high minimum guaranteed bandwidth is streaming-based dynamic image data. The streaming-based dynamic image data has a characteristic such that streaming reproduction cannot be performed below a certain transfer rate. As for the text data, a data size thereof is small, and therefore the text data has only a slight problem to the extent that transfer time is slightly lengthened. Thus, by reducing the data bandwidth from the lowest to the highest in the order of the minimum guaranteed bandwidths, it is possible to prevent streaming reproduction of the dynamic image data being transferred from being interrupted.

A seventh aspect of the present invention is directed to an access relay apparatus for transferring data, which is input by a data transmitter via a network, to a LAN system, wherein required bandwidth information, which indicates a bandwidth required for transferring the data, is embedded in the data by the data transmitter, and wherein the access relay apparatus comprises: a data receiving section for receiving the data transmitted by the data transmitter; a bandwidth recognition section for recognizing the bandwidth required for transferring the data based on the required bandwidth information embedded in the data received by the data receiving section; an occupied bandwidth recognition section for recognizing a bandwidth currently being used among bandwidths internally available to the access relay apparatus; and a determination section for determining whether sufficient bandwidth is available to the data received by the data receiving section by comparing the bandwidth required for transferring the data, which is recognized by the bandwidth recognition section, and the bandwidth currently being used, which is recognized by the occupied bandwidth recognition section.

In the seventh aspect, the access relay apparatus determines whether to transfer data by comparing a bandwidth required for data transfer and a bandwidth currently being used, and therefore when an available bandwidth of the LAN system is too narrow to transfer the data, the data is not transferred. Thus, undesirable data transfer is prevented, thereby effectively utilizing the bandwidth of the LAN system.

According to an eighth aspect based on the seventh aspect, priority information, which indicates a priority for allowing the data to use the bandwidths internally available, is embedded in the data as well as the required bandwidth information, and the access relay apparatus comprises: a priority recognition section for recognizing data-by-data priorities based on the priority information embedded in the data; and a bandwidth adjusting section for reducing a bandwidth of data, which has a priority lower than that of the data received by the data receiving section among the data-by-data priorities recognized by the priority recognition step, so as to allow the sufficient bandwidth to be available to the data received by the data receiving section when the determination section determines that no sufficient bandwidth is available to the data received by the data receiving section.

In the eighth aspect, the access relay apparatus reduces a bandwidth of data, which is being transferred and has a priority lower than that of the data received by the data receiving step, thereby allowing the data received by the data receiving step to use the bandwidth of the LAN system. Thus, it is possible to reserve a bandwidth for highly urgent data having a high priority.

A ninth aspect of the present invention is directed to a data transmitter for transmitting data to a LAN system, the data transmitter being connected to the LAN system via a network so as to be allowed to intercommunicate therewith, the data transmitter comprising: an information embedding section for embedding required bandwidth information into the data when the LAN system requests the data transmitter to transmit the data, the required bandwidth information being specific to the data and indicating a bandwidth required for transferring the data; and a data transmission section for transmitting the data having the required bandwidth information embedded therein to the LAN system via the network, wherein the LAN system performs a data-by-data determination as to whether bandwidths internally available can be used based on the required bandwidth information embedded in received data.

In the ninth aspect, the data transmitter transmits a required bandwidth embedded in data to the LAN system, and therefore the radio LAN system can determine whether to transfer the data based on the required bandwidth. Thus, a transfer rate of data being transferred is prevented from being lowered by new data, which is transmitted to the LAN system and consumes a bandwidth thereof, when the bandwidth of the LAN system becomes congested, thereby preventing streaming reproduction of video data from being interrupted.

According to a tenth aspect based on the ninth aspect, the information embedding section embeds priority information, which indicates a priority for allowing the data to use the bandwidths internally available, as well as the required bandwidth information; and the LAN system performs the data-by-data determination as to whether the bandwidths internally available can be used based on the required bandwidth information and the priority information.

In the tenth aspect, the data transmitter transmits to the LAN system priority information embedded in data as well as the required bandwidth information, and therefore the LAN system can determine whether to transfer the data based on these pieces of information. Thus, the LAN system can determine which data to be transferred or which data not to be transferred by comparing priorities of data being transferred, for example.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating an exemplary configuration of a LAN system according to the present invention;

FIG. 2 is a block diagram illustrating an exemplary configuration of a server according to the present invention;

FIG. 3 is a diagram illustrating an exemplary structure of a transfer data packet according to the present invention;

FIG. 4 is a diagram illustrating an exemplary structure of a media identification code according to the present invention;

FIG. 5 is a diagram illustrating an exemplary configuration of a required bandwidth table according to the present invention;

FIG. 6 is a diagram illustrating an exemplary configuration of a priority class table according to the present invention;

FIG. 7 is a diagram illustrating an exemplary configuration of a media identification table according to the present invention;

FIG. 8 is a block diagram illustrating a configuration of a bandwidth adjusting access point according to the present invention;

FIG. 9 is a diagram illustrating an exemplary configuration of a bandwidth management table according to the present invention;

FIG. 10 is a diagram illustrating an exemplary configuration of a minimum guaranteed bandwidth table according to the present invention;

FIG. 11 is a main flowchart of an operation performed by a transfer determination section in accordance with the present invention;

FIG. 12 is a flowchart illustrating details of a subroutine of step S15, the “priority 1 determination process”;

FIG. 13 is a flowchart illustrating details of a subroutine of step S105, the “media identification process”;

FIG. 14 is a flowchart illustrating details of a subroutine of step S130, the “undesignated data bandwidth changing process”;

FIG. 15 is a flowchart illustrating details of a subroutine of step S135, the “priority 3 data bandwidth changing process”;

FIG. 16 is a flowchart illustrating details of a subroutine of step S140, the “priority 2 data bandwidth changing process”;

FIG. 17 is a flowchart illustrating partial details of a subroutine of step S145, the “priority 1 data bandwidth changing process”;

FIG. 18 is another flowchart illustrating partial details of the subroutine of step S145, the “priority 1 data bandwidth changing process”;

FIG. 19 is a flowchart illustrating details of a subroutine of step S25, the “priority 2 data bandwidth changing process”;

FIG. 20 is a flowchart illustrating details of a subroutine of step S35, the “priority 3 determination process”;

FIG. 21 is a flowchart illustrating details of a subroutine of step S40, the “undesignated priority determination process”;

FIG. 22 is a flowchart illustrating an operation performed by a transfer control section when a transfer data packet is transmitted to an information processing apparatus;

FIG. 23 is a diagram illustrating another exemplary structure of the transfer data packet according to the present invention;

FIG. 24 is a structure of the transfer data packet when a header length field is set as “1010”;

FIG. 25 is a structure of the transfer data packet when a header length field is set as “0110”;

FIG. 26 is a block diagram illustrating another exemplary configuration of the LAN system according to the present invention;

FIG. 27 is a block diagram illustrating still another exemplary configuration of the LAN system according to the present invention;

FIG. 28 is a block diagram illustrating still another exemplary configuration of the LAN system according to the present invention; and

FIG. 29 is a block diagram illustrating an exemplary configuration of a conventional LAN system.

### DESCRIPTION OF THE PREFERRED EMBODIMENTS

(First Embodiment)

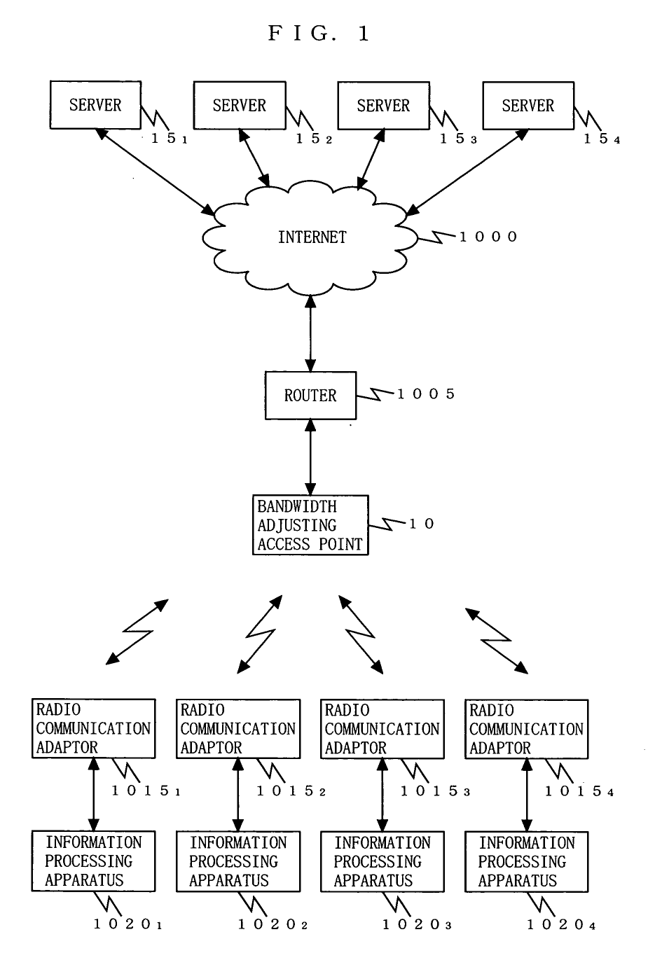

Hereinafter, a first embodiment of the present invention will be described with reference to the drawings. FIG. 1 is a block diagram illustrating a configuration of a LAN system according to the first embodiment of the present invention. This LAN system includes a bandwidth adjusting access point 10 (in the claims, referred to as the “access relay apparatus”), servers 15, to 154 (in the claims, referred to as the “data transmitters”), a router 1005, radio communication adaptors 1015₁ to 1015₄, and information processing apparatuses 1020₁ to 1020₄. In the present embodiment, the respective number of servers, radio communication adaptors, and information processing apparatuses is four. However, the respective number of these elements is not limited to four.

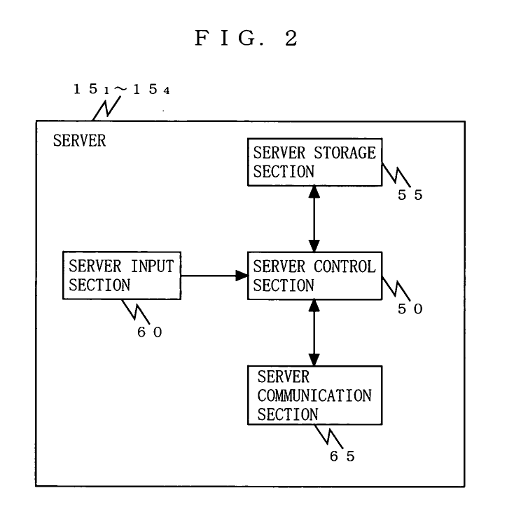

A configuration of a server 15₁ to 15₄ will now be described with reference to a drawing. FIG. 2 is a block diagram illustrating an exemplary configuration of the server 151 to 154. The server 151 to 154 includes a server control section 50, a server storage section 55, a server input section 60, and a server communication section 65. The server control section 50 is responsible for controlling the entire server 15₁ to 15₄ and realized by, for example, a CPU. The server storage section 55 stores data (hereinafter, referred to as the “transfer data”), which should be transmitted to an information processing apparatus 1020₁ to 1020₄, is realized by, for example, a hard disk. The server input section 60 is an entry means, such as a keyboard, which is used by the manager of the server for storing the transfer data into the server storage section 55. The server communication section 65 is used for exchanging information with the information processing apparatus 1020₁-1020₄. When the transfer data is stored into the server storage section 55, the server 15₁-15₄ sets required bandwidth information, priority class information, andmedia identification information in the transfer data. A structure of the transfer data, the required bandwidth information, the priority class information, and the media identification information will be described below with reference to drawings.

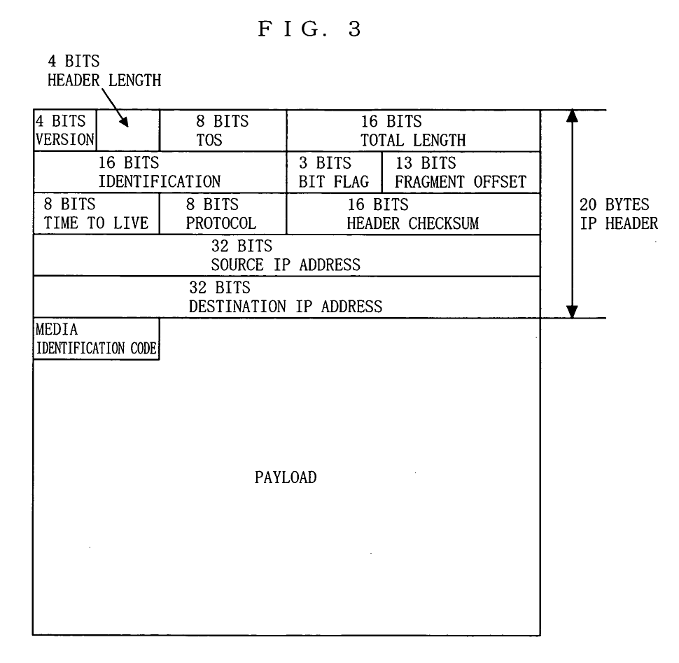

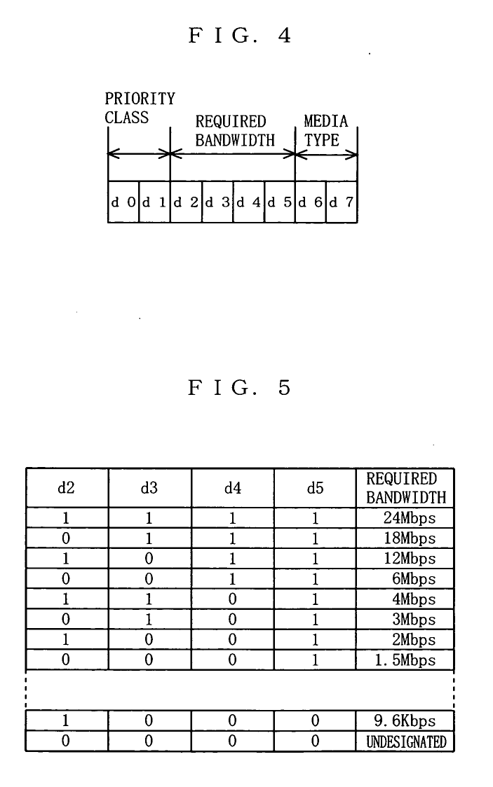

Firstly, the structure of the transfer data is described with reference to a drawing. FIG. 3 is a diagram illustrating a structure of one of packets (hereinafter, referred to as the “transfer data packets”) into which the transfer data is divided. Each transfer data packet includes an IP header and a payload. The payload includes a media identification code. The media identification code will now be described. FIG. 4 is a diagram illustrating a structure of the media identification code. The media identification code is 8-bit data including the required bandwidth information, the priority class information, and the media identification information. The priority class information is 2-bit data and represented by bits d0 and d1. The required bandwidth information is 4-bit data and represented by bits d2, d3, d4, and d5. The media identification information is 2-bit data and represented by bits d6 and d7.

The required bandwidth information will now be described. The required bandwidth information is data indicating the size of a bandwidth to be allocated to transfer data having reached a bandwidth adjusting access point. In the present embodiment, sixteen types of required bandwidths can be set as illustrated in FIG. 5. FIG. 5 is a required bandwidth table showing relationships between the required bandwidths and each bit value of the required bandwidth information.

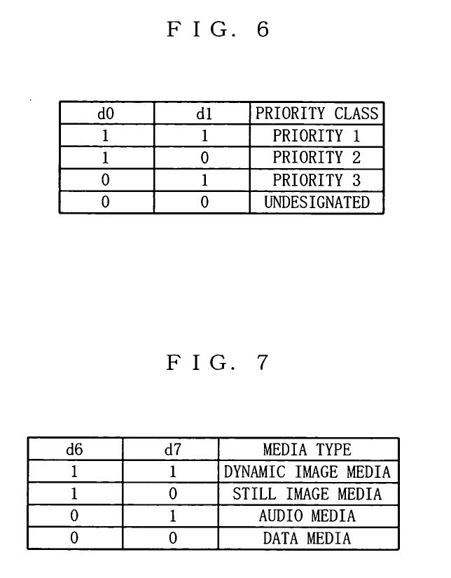

The priority class information will be described next. The priority class information indicates the priority of the transfer data having reached the bandwidth adjusting access point. The present embodiment prioritizes transferring of transfer data having a high priority over transfer data having a low priority even when the transfer data having a low priority is being transferred. Four types of priorities can be set as the priority class, as illustrated in FIG. 6. FIG. 6 illustrates a priority class table showing relationships between the required bandwidths and each bit value of the priority class information.

The media identification information will be described next. The media identification information indicates what type of data the transfer data is. In the present embodiment, as illustrated in FIG. 7, the media identification information can be set so as to indicate any one of four types of media, such as a dynamic image medium, a still image medium, an audio medium, and a data medium (e.g., text data or the like having a small data size).

Referring to FIG. 1, the router 1005 is connected to a bandwidth adjusting access point 10 and the internet 1000, and has a routing function. The bandwidth adjusting access point 10 has a function of communicating with each of the radio communication adaptors 1015₁ to 1015₄ by radio. The information processing apparatuses 1020₁ to 1020₄ are connected to a corresponding one of the radio communication adaptors 1015₁ to 1015₄.

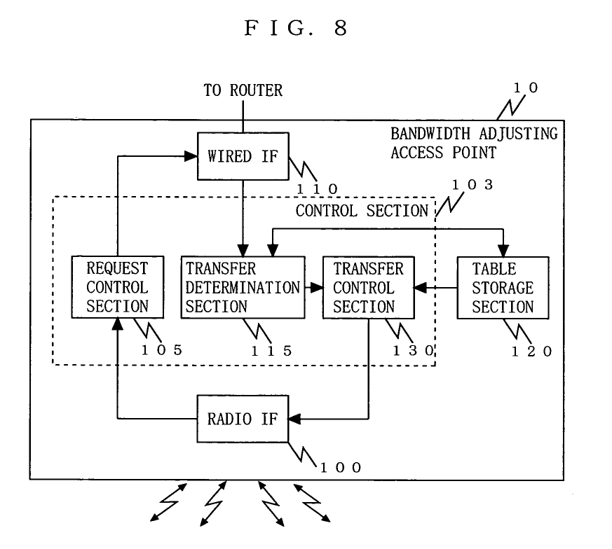

The bandwidth adjusting access point 10 will now be described with reference to a drawing. FIG. 8 is a block diagram illustrating a detailed configuration of the bandwidth adjusting access point 10. The bandwidth adjusting access point 10 includes a radio IF 100, a control section 103, and a table storage section 120. The control section 103 includes a request control section 105, a transfer determination section 115, and a transfer control section 130.

The radio IF 100 exchanges data with the radio communication adaptors 1015₁ to 1015₄ by radio. The request control section 105 causes a wired IF 110 to transmit to the servers 151 to 15₄ a request to transmit transfer data (hereinafter, referred to as the “transfer data transmission request”), which is transmitted from a corresponding one of the information processing apparatuses 1020₁ to 1020₄. The wired IF 110 is responsible for outputting the transfer data transmission request to the router 1005 and outputting transfer data, which has been acquired from the router 1005, to the transfer determination section 115. The transfer determination section 115 refers to a media identification code of the transfer data acquired via the wired IF 110, and determines the size of a bandwidth to be allocated to each of the information processing apparatuses 1020₁ to 1020₄. The table storage section 120 stores a bandwidth management table, a temporary bandwidth management table, a required bandwidth table, a priority class table, a media type table, and a minimum guaranteed bandwidth table. The transfer control section 130 causes the wired IF 110 to transmit to the radio communication adaptors 1015₁ to 1015₄ the transfer data in sizes adapted for respective bandwidths allocated to the information processing apparatuses 1020₁ to 1020₄.

The above-described various types of tables stored in the table storage section 120 will now be described with reference to drawings.

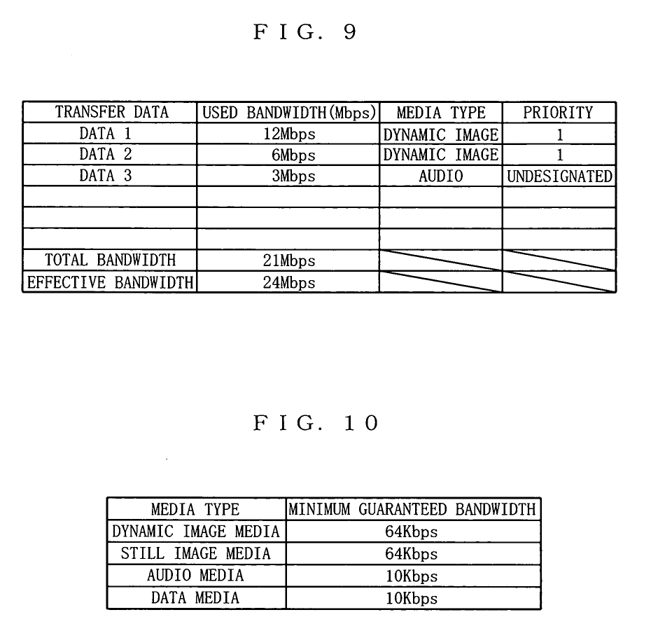

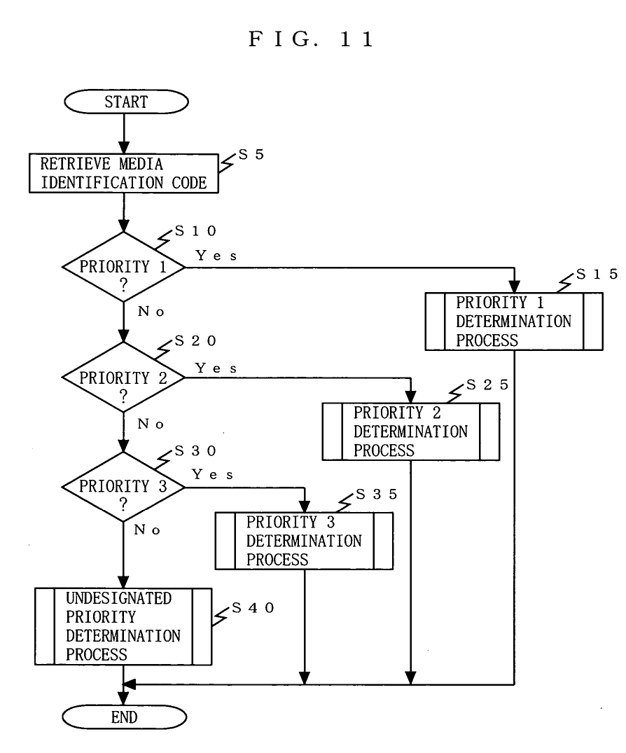

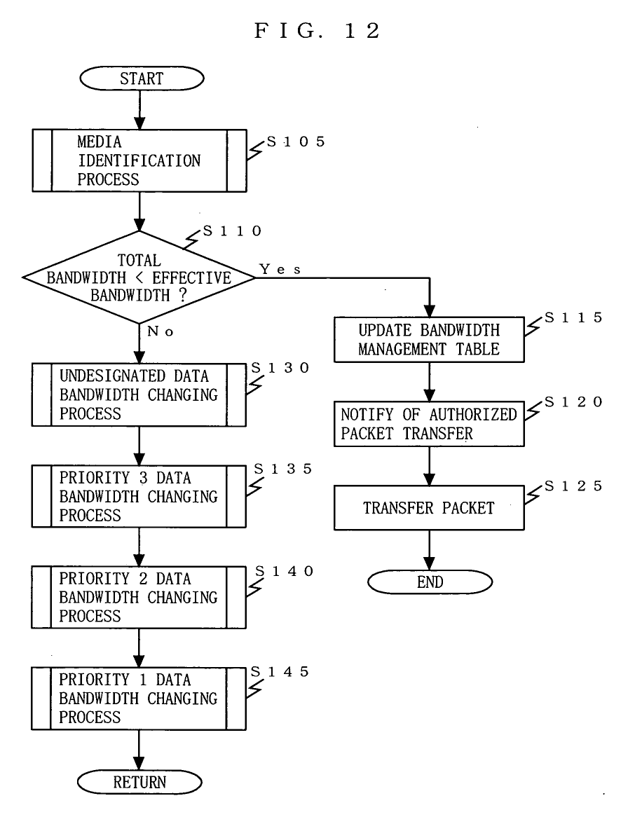

Firstly, the bandwidth management table will be described with reference to FIG. 9. FIG. 9 illustrates an exemplary configuration of the bandwidth management table. The bandwidth management table includes fields for a transfer data name, a used bandwidth, a media type, a priority, a total bandwidth (in the claims, referred to as the “occupied bandwidth”), and an effective bandwidth. In the fields for the transfer data name, names of transfer data currently being transferred are registered. In the fields for the used bandwidth, sizes of the bandwidths allocated to the transfer data are registered. In the fields for the media type, media types of transfer data packets currently being transferred are registered. In the fields for the priority, priorities of the transfer data packets currently being transferred are registered. In the field for the total bandwidth, the total value of the bandwidths currently being used is registered. In the fields for the effective bandwidth, the maximum possible bandwidth for the bandwidth adjusting access point 10, which is available for transmitting data to the radio communication adaptors 1015₁ to 1015₄, is registered.

Next, the temporary bandwidth management table will be described. Similar to the bandwidth management table, an exemplary configuration of the temporary bandwidth management table is realized in the form illustrated in FIG. 9. Functions of fields in the temporary bandwidth management table are similar to those of corresponding fields in the above-described bandwidth management table, and therefore description thereof is omitted. A function of the temporary bandwidth management table will now be described. The temporary bandwidth management table is used for temporarily registering a used bandwidth for each transfer data on the assumption that new transfer data packets to be transferred to the information processing apparatuses 1020₁ to 1020₄ are actually transferred thereto when such transfer data packets reach the transfer determination section 115. The transfer determination section 115 uses the temporary bandwidth management table to determine whether to transfer the transfer data packets to the information processing apparatuses 1020₁ to 1020₄.

Next, the minimum guaranteed bandwidth table will be described. FIG. 10 is a diagram illustrating an exemplary configuration of the minimum guaranteed bandwidth table. The minimum guaranteed bandwidth table is referred to in the case where the bandwidth adjusting access point 10 acquires transfer data having a required bandwidth which is not designated. More specifically, the transfer determination section 115 allocates a bandwidth, which has a size of the minimum guaranteed bandwidth corresponding to a media type, to the transfer data having the required bandwidth which is not designated.

Operations of the thus-configured LAN system will be described below. Each process described in the present embodiment may be realized in the form of software by using a computer or in the form of hardware circuits exclusively used for performing respective processes.

An operation performed by the LAN system when the information processing apparatus 1020₁ transmits a transfer data transmission request to the server 15₁ will be described with reference to FIG. 1.

Firstly, the information processing apparatus 1020₁ generates a signal (hereinafter, referred to as the “transmission request signal”) for requesting the server 15₁ to transmit the transfer data, and outputs the generated transmission request signal to the radio communication adaptor 1015₁. The radio communication adaptor 1015 converts the acquired transmission request signal into a radio wave, and transmits the resultant radio wave to the bandwidth adjusting access point 10. The radio IF 100 of the bandwidth adjusting access point 10 accordingly receives the radio wave corresponding to the transmission request signal. Then, the radio IF 100 converts the radio wave corresponding to the acquired transfer request signal back to the transfer request signal, and outputs the transfer request signal to the request control section 105.

The request control section 105 having received the transfer request signal outputs the transfer request signal to the router 1005 via the wired IF 110. Thereafter, the transfer request signal is routed through the internet 1000 to the server communication section 65 of the server 15₁. Then, the server communication section 65 outputs the transfer data packets to the server control section 50. The server control section 50, which has acquired the transfer request signal, acquires transfer data requested by the information processing apparatus 1020₁ from the server storage section 55, divides the transfer data into packets, and embeds a media identification code in a payload portion of each packet. The server control section 50 causes the server communication section 65 to transmit the transfer data to the information processing apparatus 1020₁. In the present embodiment, for example, window control may be used for sequentially transmitting the transfer data packets.

Described below is an operation performed by the LAN system when the transfer data is delivered from the server 151 to the bandwidth adjusting access point 10.

Transfer data packets output by the server 15, are routed through the internet 1000 to the router 1005. The router 1005 refers to IP addresses of the transfer data packets and determines whether to pass the transfer data therethrough. When the router 1005 determines that the transfer data packets should be passed therethrough, the transfer data packets are output to the bandwidth adjusting access point 10. On the other hand, when the router 1005 determines that the transfer data packets should not be passed therethrough, the transfer data packets are discarded.

The transfer data packets, which have passed through the router 1005, are received by the wired IF 110 illustrated in FIG. 8. Thus, the operation performed by the LAN system when the transfer data is delivered from the server 151 to the bandwidth adjusting access point 10 has been described.

Next, an operation performed by the bandwidth adjusting access point 10 in the case where a bandwidth is allocated to the transfer data packets will be described with reference to drawings.

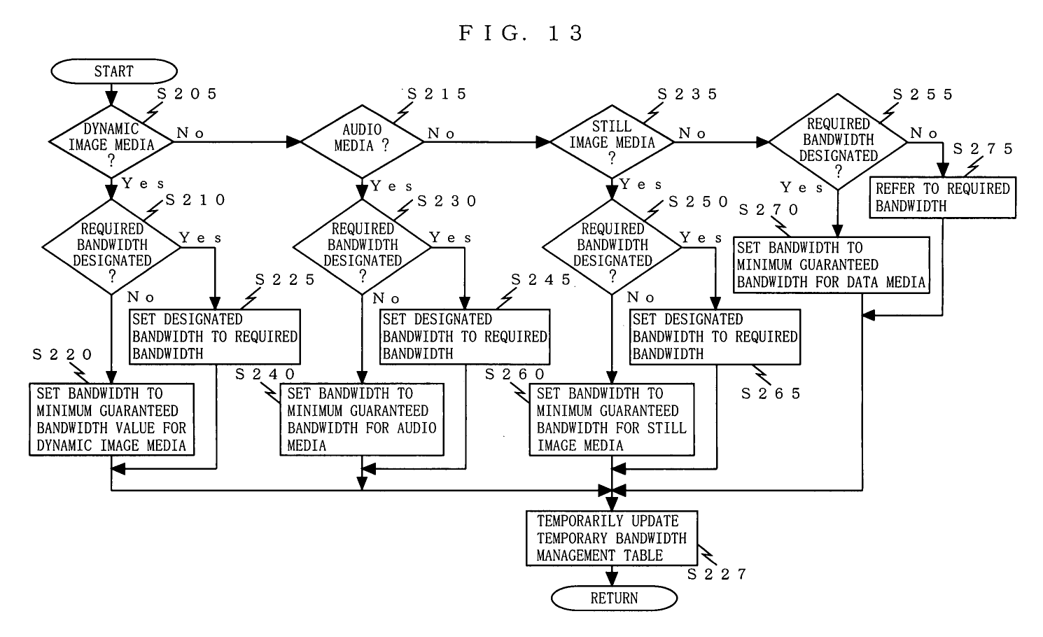

FIGS. 11 to 20 are flowcharts illustrating an operation performed by the transfer determination section 115 for such a case.

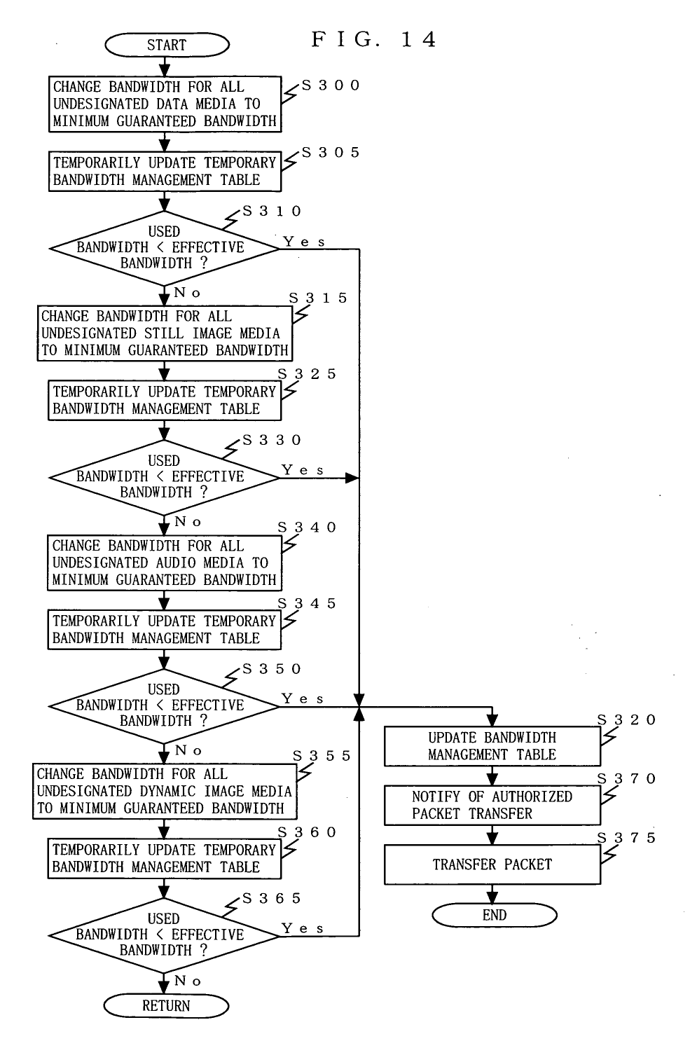

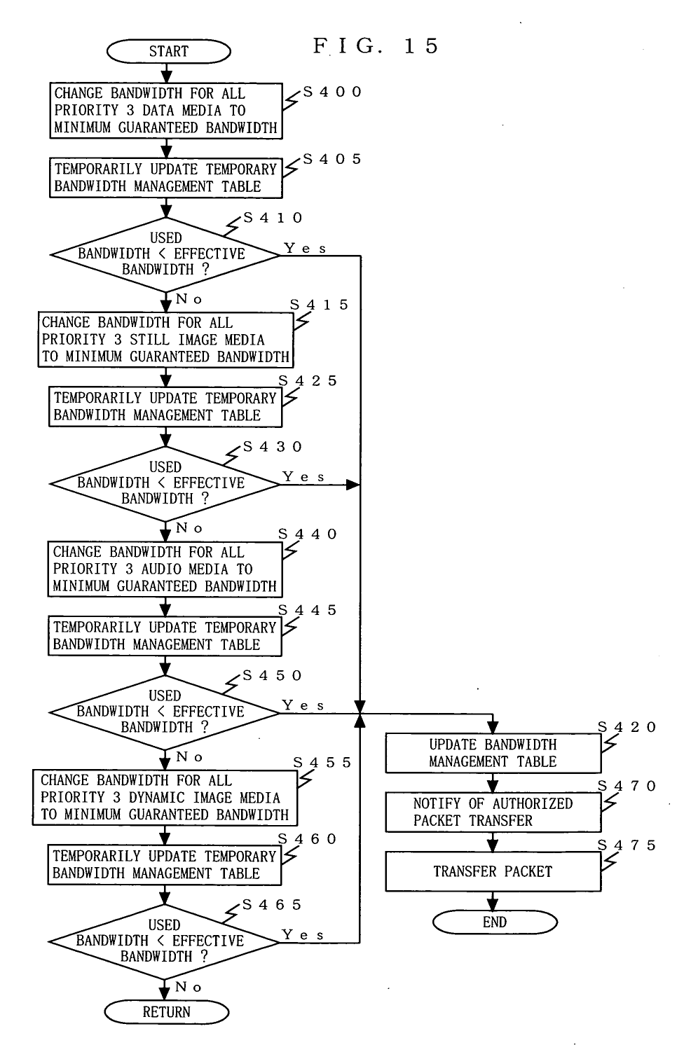

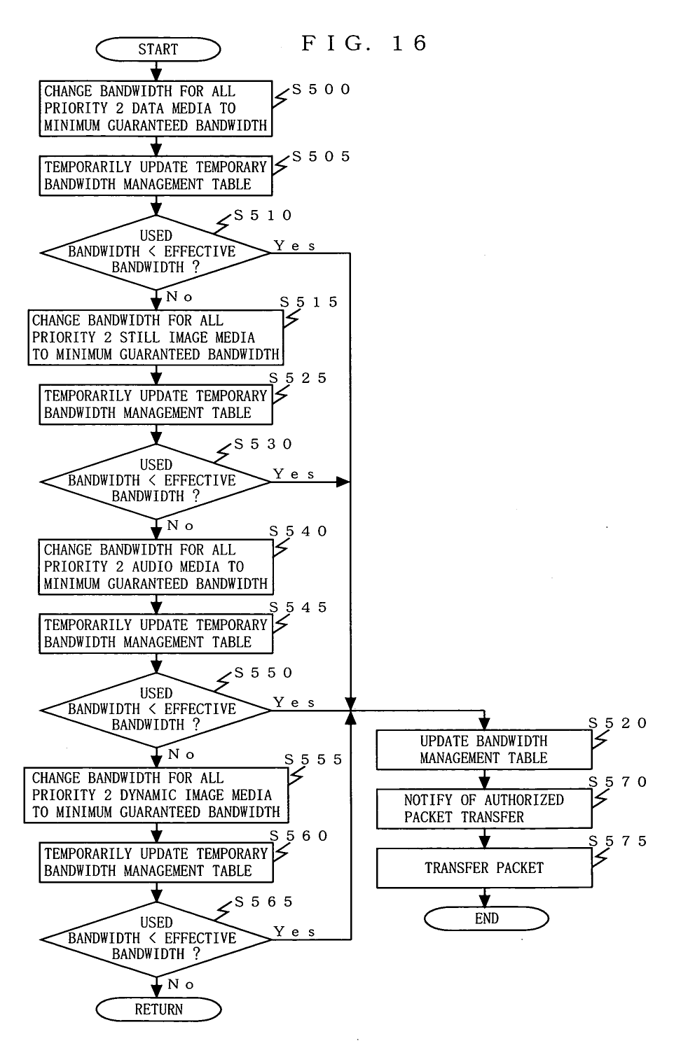

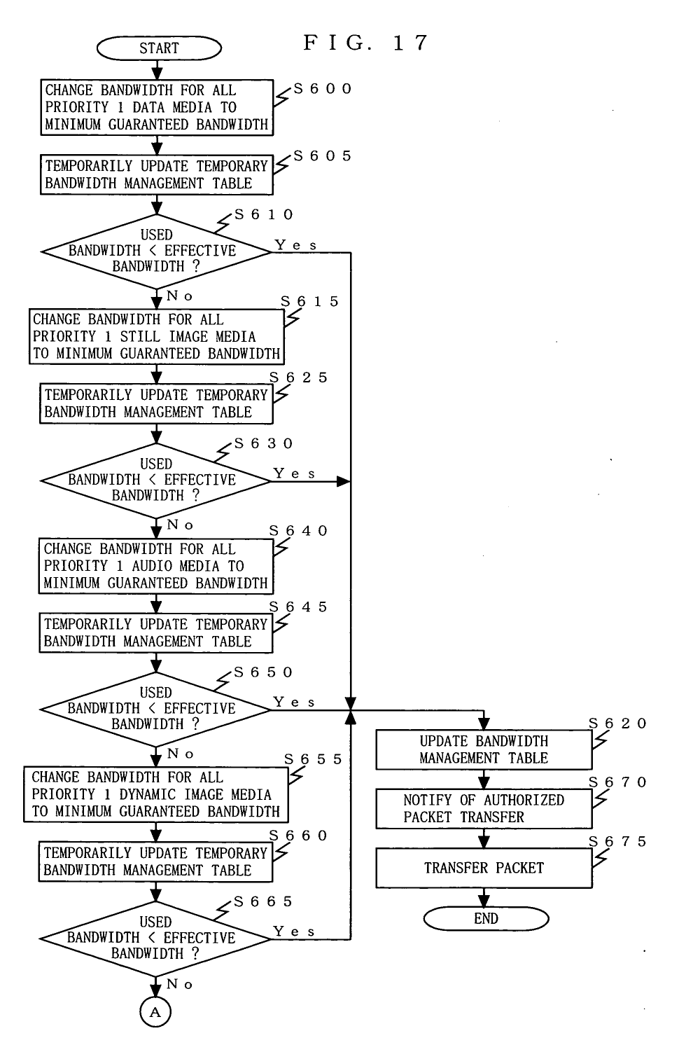

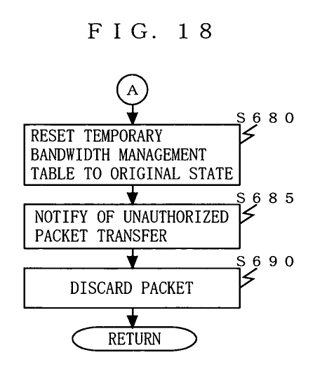

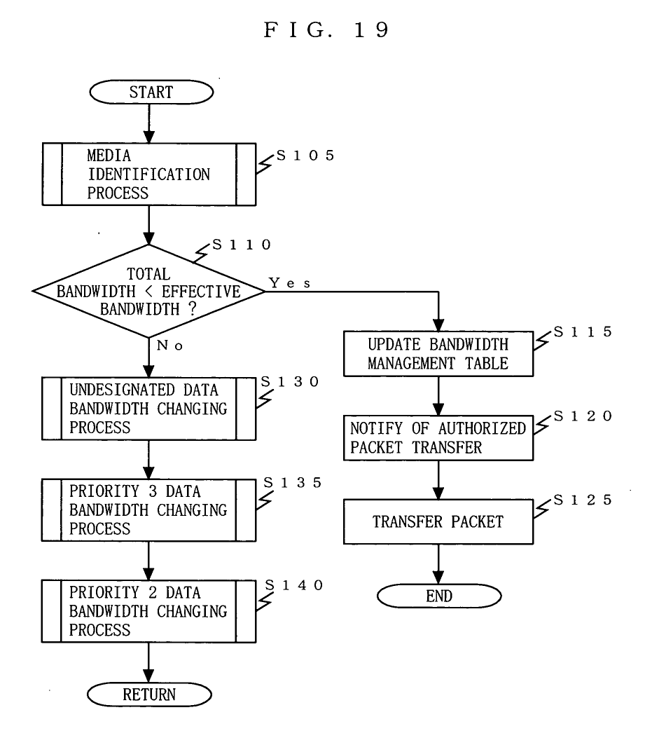

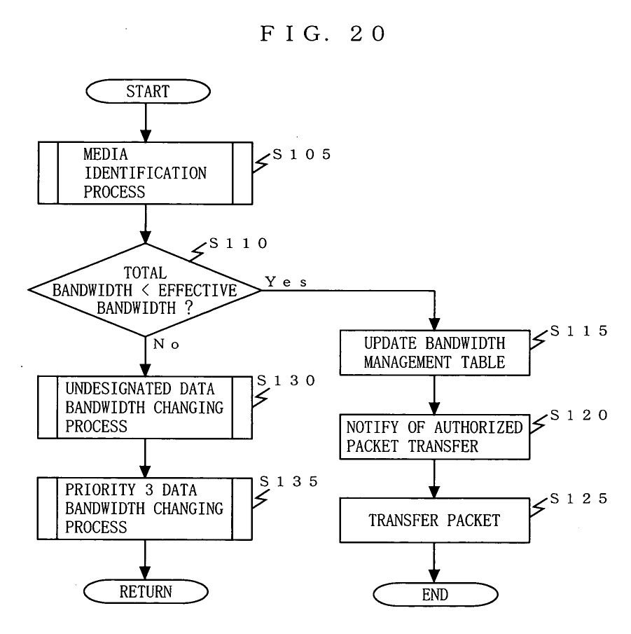

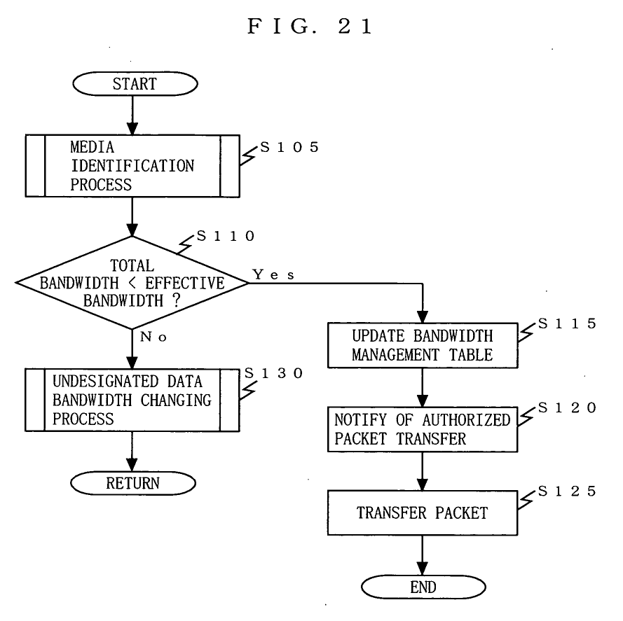

The following is description of the figures. FIG. 11 is a main flowchart of the procedure. FIG. 12 is a flowchart illustrating details of a subroutine of step S15, the “priority 1 determination process”. FIG. 13 is a flowchart illustrating details of a subroutine of step S105, the “media identification process”. FIG. 14 is a flowchart illustrating details of a subroutine of step S130, the “undesignated data bandwidth changing process”. FIG. 15 is a flowchart illustrating details of a subroutine of step S135, the “priority 3 data bandwidth changing process”. FIG. 16 is a flowchart illustrating details of a subroutine of step S140, the “priority 2 data bandwidth changing process”. FIGS. 17 and 18 are flowcharts illustrating details of a subroutine of step S145, the “priority 1 data bandwidth changing process”. FIG. 19 is a flowchart illustrating details of a subroutine of step S25, the “priority 2 determination process”. FIG. 20 is a flowchart illustrating details of a subroutine of step S35, the “priority 3 determination process”. FIG. 21 is a flowchart illustrating details of a subroutine of step S40, the “undesignated priority determination process”.

The procedure is started when the transfer determination section 115 acquires the transfer data packets from the wired IF 110.

The transfer determination section 115 having acquired the transfer data packets retrieves a media identification code from the acquired transfer data packets (step S5). Then, the transfer determination section 115 acquires a priority class table illustrated in FIG. 6 from the table storage section 120. The transfer determination section 115, which has acquired the priority class table, refers to a priority class table for the priority class, and determines whether the transfer data packets have priority 1 assigned thereto (step S10). When it is determined that the transfer data packets have priority 1 assigned thereto, the procedure proceeds to step S15. On the other hand, when it is determined that the transfer data packets do not have priority 1 assigned thereto, the procedure proceeds to step S20. Described below is an operation performed by the transfer determination section 115 when the transfer data packets have priority 1 assigned thereto.

At step S15, the transfer determination section 115 performs the “priority 1 determination process”. The “priority 1 determination process” means a process performed when the acquired transfer data packets have priority 1 assigned thereto, where the transfer determination section 115 determines whether to transfer the transfer data packets to the information processing apparatuses 1020₁ to 1020₄. The “priority 1 determination process” will be described below with reference to FIG. 12.

Firstly, the transfer determination section 115 performs a media identification process for identifying a media type of the acquired transfer data packets (step S105). FIG. 13 is a flowchart illustrating details of the media identification process (step S105). The media identification process will be described in detail below with reference to FIG. 13.

The transfer determination section 115 determines whether the acquired transfer data packets are the dynamic image media (step S205). When it is determined that the acquired transfer data packets are the dynamic image media, the procedure proceeds to step S210. On the other hand, when it is determined that the acquired transfer data packets are not the dynamic image media, the procedure proceeds to step S215.

When the acquired transfer data packets are the dynamic image media, the transfer determination section 115 acquires the required bandwidth table illustrated in FIG. 9 from the table storage section 120. Then, the transfer determination section 115 refers to the required bandwidth table and determines whether the required bandwidth for the transfer data packets is designated (step S210). When the required bandwidth is not designated, the procedure proceeds to step S220. On the other hand, when the required bandwidth is designated, the procedure proceeds to step S225.

When the required bandwidth is not designated, the transfer determination section 115 acquires the minimum guaranteed bandwidth table illustrated in FIG. 10 from the table storage section 120. Then, the transfer determination section 115 refers to the minimum guaranteed bandwidth table and sets the bandwidth of the acquired transfer data packets to the minimum guaranteed bandwidth for the dynamic image media (step S220). Thereafter, the procedure proceeds to step S227.

On the other hand, when the required bandwidth is designated, the transfer determination section 115 refers to the required bandwidth table for the required bandwidth and specifies a required bandwidth for the transfer data packets. Then, the transfer determination section 115 sets the bandwidth of the acquired transfer data packets to the required bandwidth (step S225). Thereafter, the procedure proceeds to step S227.

At step S227, the transfer determination section 115 temporarily updates the temporary bandwidth management table to the set bandwidth. More specifically, the transfer determination section 115 registers the transfer data packets in the temporary bandwidth management table with respect to a data name, a used bandwidth, a media type, and a priority, and calculates the total bandwidth. Thereafter, the procedure proceeds to step S110 of FIG. 12.

When it is determined that the transfer data packets are not the dynamic image media at step S205, the transfer determination section 115 determines whether the acquired transfer data packets are audio media (step S215). When the acquired transfer data packets are the audio media, the procedure proceeds to step S230. On the other hand, when the acquired transfer data is not the audio media, the procedure proceeds to step S235.

When the acquired transfer data is the audio media, the transfer determination section 115 acquires the required bandwidth table from the table storage section 120. Then, the transfer determination section 115 refers to the required bandwidth table and determines whether the required bandwidth for the transfer data packets is designated (step S230). When the required bandwidth is not designated, the procedure proceeds to step S240. On the other hand, when the required bandwidth is designated, the procedure proceeds to step S245.

When the required bandwidth is not designated, the transfer determination section 115 acquires the minimum guaranteed bandwidth table from the table storage section 120. Then, the transfer determination section 115 refers to the minimum guaranteed bandwidth table and sets the bandwidth of the acquired transfer data packets to the minimum guaranteed bandwidth for the audio media (step S240). Thereafter, the procedure proceeds to step S227.

On the other hand, when the required bandwidth is designated, the transfer determination section 115 refers to the required bandwidth table and specifies a required bandwidth for the transfer data packets. Then, the transfer determination section 115 sets the bandwidth of the transfer data packets to the required bandwidth (step S245). Thereafter, the procedure proceeds to step S227.

At step S227, the transfer determination section 115 temporarily updates the temporary bandwidth management table to the set bandwidth. Thereafter, the procedure proceeds to step S110 of FIG. 12.

When it is determined that the transfer data packets are not the audio media at step S215, the transfer determination section 115 determines whether the acquired transfer data packets are still image media (step S235). When the acquired transfer data packets are the still image media, the procedure proceeds to step S250. On the other hand, when the acquired transfer data is not the still image media, the procedure proceeds to step S255.

When the acquired transfer data is the still image media, the transfer determination section 115 acquires the required bandwidth table from the table storage section 120. Then, the transfer determination section 115 refers to the required bandwidth table and determines whether the required bandwidth for the transfer data packets is designated (step S250). When the required bandwidth is not designated, the procedure proceeds to step S260. On the other hand, when the required bandwidth is designated, the procedure proceeds to step S265.

When the required bandwidth is not designated, the transfer determination section 115 acquires the minimum guaranteed bandwidth table from the table storage section 120. Then, the transfer determination section 115 refers to the minimum guaranteed bandwidth table and sets the bandwidth of the acquired transfer data packets to the minimum guaranteed bandwidth for the still image media (step S260). Thereafter, the procedure proceeds to step S227.

On the other hand, when the required bandwidth is designated, the transfer determination section 115 refers to the required bandwidth table and specifies a required bandwidth for the transfer data packets. Then, the transfer determination section 115 sets the bandwidth of the acquired transfer data packets to the required bandwidth (step S265). Thereafter, the procedure proceeds to step S227.

At step S227, the transfer determination section 115 temporarily updates the temporary bandwidth management table to the set bandwidth (step S227). Thereafter, the procedure proceeds to step S110 of FIG. 12.

When it is determined that the transfer data packets are not the still image media at step S235, the transfer determination section 115 determines that the transfer data packets are data media. Then, the transfer determination section 115 acquires the required bandwidth table from the table storage section 120. Thereafter, the transfer determination section 115 refers to the required bandwidth table and determines whether the required bandwidth for the transfer data packets is designated (step S255). When the required bandwidth is not designated, the procedure proceeds to step S270. On the other hand, when the required bandwidth is designated, the procedure proceeds to step S275.

When the required bandwidth is not designated, the transfer determination section 115 acquires the minimum guaranteed bandwidth table from the table storage section 120. Then, the transfer determination section 115 refers to the minimum guaranteed bandwidth table and sets the bandwidth of the acquired transfer data packets to the minimum guaranteed bandwidth for the data media (step S270). Thereafter, the procedure proceeds to step S227.

On the other hand, when the required bandwidth is designated, the transfer determination section 115 refers to the required bandwidth table and specifies a required bandwidth for the transfer data packets. Then, the transfer determination section 115 sets the bandwidth of the acquired transfer data packets to the required bandwidth (step S275). Thereafter, the procedure proceeds to step S227.

At step S227, the transfer determination section 115 temporarily updates the temporary bandwidth management table to the set bandwidth (step S227). Thereafter, the procedure proceeds to step S110 of FIG. 12. Thus, the media identification process of step S105 has been described.

Referring to FIG. 12, when the media identification process is completed, the transfer determination section 115 refers to the fields for the effective bandwidth and the total bandwidth in the temporary bandwidth management table and determines whether the effective bandwidth is greater than the total bandwidth (step S110). In this process, whether new data packets can be transmitted using an unused bandwidth is determined. When the effective bandwidth is greater than the total bandwidth, the procedure proceeds to the step S115. On the other hand, when the effective bandwidth is not greater than the total bandwidth, the procedure proceeds to step S130.

When the effective bandwidth is greater than the total bandwidth, the bandwidth adjusting access point 10 determines that data packets can be transferred, and therefore starts a process for transferring the transfer data packets. More specifically, the transfer determination section 115 updates the bandwidth management table so as to have the same contents as those of the temporary bandwidth management table (step S115). Then, the transfer determination section 115 notifies the transfer control section 120 that the transfer data packets are authorized to be transferred (step S120). The transfer control section 120 accordingly causes the radio IF to start transferring of the transfer data packets (step S125). In the present embodiment, only a first transfer data packet is referred to for the media identification code. Accordingly, second and subsequent transfer data packets are passed through the transfer determination section 115 to the transfer control section 130.

On the other hand, when the effective bandwidth is not greater than the total bandwidth, the transfer determination section 115 performs the “undesignated data bandwidth setting process” (step S130). In the “undesignated data bandwidth setting process”, among transfer data currently being transferred, the transfer determination section 115 changes the bandwidth of transfer data whose priority class is not designated to the minimum guaranteed bandwidth, thereby allowing newly acquired transfer data packets to be transferred. The “undesignated data bandwidth setting process” will be described below with reference to FIG. 14.

Firstly, among the transfer data packets currently being transferred, the transfer determination section 115 changes the bandwidth of the data media whose priority class is not designated, to the minimum guaranteed bandwidth (step S300). Then, the transfer determination section 115 temporarily updates the temporary bandwidth management table such that the changed bandwidth is set therein (step S305). Then, the transfer determination section 115 refers to the temporary bandwidth management table and determines whether the effective bandwidth is greater than the used bandwidth (step S310). When the effective bandwidth is not greater than the used bandwidth, the procedure proceeds to step S315. On the other hand, when the effective bandwidth is greater than the used bandwidth, the procedure proceeds to step S320 at which the bandwidth adjusting access point 10 starts to transfer the packets.

When the effective bandwidth is not greater than the used bandwidth, among the transfer data packets currently being transferred, the transfer determination section 115 changes the bandwidth of the still image media whose priority class is not designated, to the minimum guaranteed bandwidth (step S315). Then, the transfer determination section 115 temporarily updates the temporary bandwidth management table such that the changed bandwidth is set therein (step S325). Then, the transfer determination section 115 refers to the temporary bandwidth management table and determines whether the effective bandwidth is greater than the used bandwidth (step S330) When the effective bandwidth is greater than the used bandwidth, the procedure proceeds to step S320 at which the bandwidth adjusting access point 10 starts to transfer the packets. On the other hand, when the effective bandwidth is not greater than the used bandwidth, the procedure proceeds to step S340.

When the effective bandwidth is not greater than the used bandwidth, among the transfer data packets currently being transferred, the transfer determination section 115 changes the bandwidth of the audio media whose priority class is not designated, to the minimum guaranteed bandwidth (step S340). Then, the transfer determination section 115 temporarily updates the temporary bandwidth management table such that the changed bandwidth is set therein (step S345). Then, the transfer determination section 115 refers to the temporary bandwidth management table and determines whether the effective bandwidth is greater than the used bandwidth (step S350). When the effective bandwidth is greater than the used bandwidth, the procedure proceeds to step S320 at which the bandwidth adjusting access point 10 starts to transfer the packets. On the other hand, when the effective bandwidth is not greater than the used bandwidth, the procedure proceeds to step S355.

When the effective bandwidth is not greater than the used bandwidth, among the transfer data packets currently being transferred, the transfer determination section 115 changes the bandwidth of the dynamic image media whose priority class is not designated, to the minimum guaranteed bandwidth (step S355). Then, the transfer determination section 115 temporarily updates the temporary bandwidth management table such that the changed bandwidth is set therein (step S360). Then, the transfer determination section 115 refers to the temporary bandwidth management table and determines whether the effective bandwidth is greater than the used bandwidth (step S365). When the effective bandwidth is not greater than the used bandwidth, the procedure proceeds to step S135 of FIG. 12. On the other hand, when the effective bandwidth is greater than the used bandwidth, the procedure proceeds to step S320.

At step S320, the transfer determination section 115 updates the bandwidth management table (step S320). Thereafter, the procedure proceeds through step S370 to step S375. Steps S320, S370, and S375 are similar to steps S115, S120, and S125, respectively, and therefore description thereof is omitted. As described above, by sequentially reducing the data bandwidth from the lowest to the highest in the order of a transfer rate, a bandwidth is reserved for a data packet to be transmitted anew. Thus, the “undesignated data bandwidth setting process” has been described.

When the effective bandwidth is not greater than the used bandwidth at step S365, the transfer determination section 115 performs the “priority 3 data bandwidth changing process” of step S135. The “priority 3 data bandwidth changing process” will be described below with reference to FIG. 15. In the “priority 3 data bandwidth changing process”, the transfer determination section 115 makes a change to the transfer data currently being transferred such that a bandwidth of transfer data having priority 3 assigned thereto is set to the minimum guaranteed bandwidth, thereby allowing the newly acquired transfer data packets to be transferred.

As can be seen from FIG. 15, the “priority 3 data bandwidth changing process” is similar to the process of FIG. 14 except that the priority class to which the process of FIG. 15 is directed is priority 3, and therefor detailed description thereof is omitted. When the bandwidth for the newly acquired transfer data packets is successfully reserved by the “priority 3 data bandwidth changing process”, the bandwidth adjusting access point 10 starts to transfer such transfer data packets (steps S420, S470, and S475). On the other hand, when the “priority 3 data bandwidth changing process” fails to reserve the bandwidth for the newly acquired transfer data packets, the procedure proceeds to step S140, the “priority 2 data bandwidth changing process”. The “priority 2 data bandwidth changing process” will be described below with reference to a drawing.

As can be seen from FIG. 16, the “priority 2 data bandwidth changing process” is similar to the process of FIG. 14 except that the priority class to which the process of FIG. 16 is directed is priority 2, and therefor detailed description thereof is omitted. When the bandwidth for the newly acquired transfer data packets is successfully reserved by the “priority 2 data bandwidth changing process”, the bandwidth adjusting access point 10 starts to transfer such transfer data packets (steps S520, S570, and S575). On the other hand, when the “priority 2 data bandwidth changing process” fails to reserve the bandwidth for the newly acquired transfer data packets, the procedure proceeds to step S145, the “priority 1 data bandwidth changing process”. The “priority 1 data bandwidth changing process” will be described below with reference to a drawing.

Steps S600 to S675 of the “priority 1 data bandwidth changing process” are similar to steps S300 to S375 of FIG. 14 except that the priority class to which steps S600 to S675 are directed is priority 1, and therefor detailed description thereof is omitted.

Processing from steps S680 to S690 of the “priority 1 data bandwidth changing process” will be described below. The processing of steps S680 to S690 is performed when a sufficient bandwidth cannot be reserved for the newly acquired transfer data packets even by changing the bandwidth of transfer data having priority 1 assigned thereto to the minimum guaranteed bandwidth.

This processing is started when the transfer determination section 115 determines that the effective bandwidth is not greater than the used bandwidth at step S665. In this case, firstly, the transfer determination section 115 resets the temporary bandwidth management table to the state before the newly acquired transfer data packets are not acquired yet (step S680) Next, the transfer determination section 115 notifies the transfer control section 130 that the newly acquired transfer data packets are not authorized to be transferred since the bandwidth cannot be reserved therefor (hereinafter, such a notification is referred to as the “unauthorized packet transfer notice”) (step S685). Thereafter, the transfer determination section 115 discards the newly acquired transfer data packets (step S690). In this case, as a matter of course, no transfer data packets are transferred to the information processing apparatuses 1020₁ to 1020₄. In the present embodiment, window control is used for sequentially transferring the transfer data packets. In the data transmission method based on the window control, when the information processing apparatuses 1020₁ to 1020₄ acquire a prescribed number of transfer data packets, each of the information processing apparatuses 1020₁ to 1020₄ transmits to a corresponding one of the servers 15, to 15₄ a confirmation response packet for motifying that the prescribed number of transfer data packets are received, and responsive to the confirmation response packets, the servers 15₁ to 15₄ transmit follow-up transfer data packets. Accordingly, if the transfer data packets are discarded at step S690, no confirmation response packets are transmitted to the servers 15₁ to 15₄. In such a case, when the servers 15₁ to 15₄ do not receive the confirmation response packets after a prescribed time period lapses, the servers 15₁ to 15₄ cancel the transmission of the follow-up transfer data packets. Thus, the “priority 1 determination process” of step S15 of FIG. 11 has been described.

Referring to FIG. 11, when it is determined that the priority class of the transfer data packets is not priority 1 at step S10, the procedure proceeds to step S20. At step S20, the transfer determination section 115 determines whether the priority class of the acquired transfer data packets is priority 2 (step S20). When the priority class is priority 2, the procedure proceeds to step S25. On the other hand, when the priority class is not priority 2, the procedure proceeds to step S30.

At step S25, the transfer determination section 115 performs the “priority 2 determination process”. In the “priority 2 determination process”, when the transfer data packets have priority 2 assigned thereto, the transfer determination section 115 determines whether to transfer the acquired transfer data packets to the information processing apparatuses 1020₁ to 1020₄. The “priority 2 determination process” will be described below with reference to FIG. 19.

Steps S105 to S140 of the “priority 2 determination process” are the same as those of FIG. 12, and therefor detailed description thereof is omitted. In the “priority 2 determination process”, the “priority 1 data bandwidth changing process” (step S145) is not performed. The reason for this is that the “priority 2 determination process” aims to reserve a bandwidth for newly acquired transfer data packets having priority 2 assigned thereto by changing bandwidths of transfer data packets having a priority class which is priority 2 or lower. Thus, the “priority 2 determination processing” has been described.

Referring to FIG. 11, when it is determined that the priority class of the transfer data packets is not priority 1 at step S20, the procedure proceeds to step S30. At step S30, the transfer determination section 115 determines whether the priority class of the acquired transfer data packets is priority 3 (step S30). When the priority class is priority 3, the procedure proceeds to step S35. On the other hand, when the priority class is not priority 3, the procedure proceeds to step S40.

When the priority class is priority 3, the transfer determination section 115 performs the “priority 3 determination process (step S30). In the “priority 3 determination process”, when the acquired transfer data packets have priority 3 assigned thereto, the transfer determination section 115 determines whether to transfer the transfer data packets to the information processing apparatuses 1020₁ to 1020₄. The “priority 3 determination process” will be described below with reference to FIG. 20.

Steps S105 to S135 of the “priority 3 determination process” are the same as those of FIG. 12, and therefor detailed description thereof is omitted. In the “priority 3 determination process”, the “priority 1 data bandwidth changing process” (step S145) and the “priority 2 data bandwidth changing process” (step S140) are not performed. The reason for this is that the “priority 3 determination process” aims to reserve a bandwidth for newly acquired transfer data packets having priority 3 assigned thereto by changing bandwidths of transfer data packets having a priority class which is priority 3 or lower. Thus, the “priority 3 determination processing” has been described.

On the other hand, when the priority class is not priority 3, the transfer determination section 115 performs the “undesignated priority determination process” (step S40). In the “undesignated priority determination process”, when the priority class of acquired transfer data packets is not designated, the transfer determination section 115 determines whether to transfer the transfer data packets to the information processing apparatuses 1020₁ to 1020₄. The “undesignated priority determination process” will be described below with reference to FIG. 21.

Steps S105 to S130 of the “undesignated priority determination process” are the same as those of FIG. 12, and therefor detailed description thereof is omitted. In the “undesignated priority determination process”, the “priority 1 data bandwidth changing process” (step S145), the “priority 2 data bandwidth changing process” (step S140), and the “priority 3 data bandwidth changing process” (step S135) are not performed. The reason for this is that the “undesignated priority determination process” aims to reserve a bandwidth for the newly acquired transfer data packets having an undesignated priority class by changing a bandwidth of transfer data packets having an undesignated priority class. Thus, the “undesignated priority determination process” has been described, and the operation performed by the bandwidth adjusting access point 10 in the case where a bandwidth is allocated to the transfer data packets has been described.

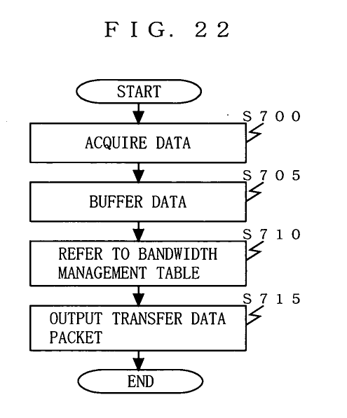

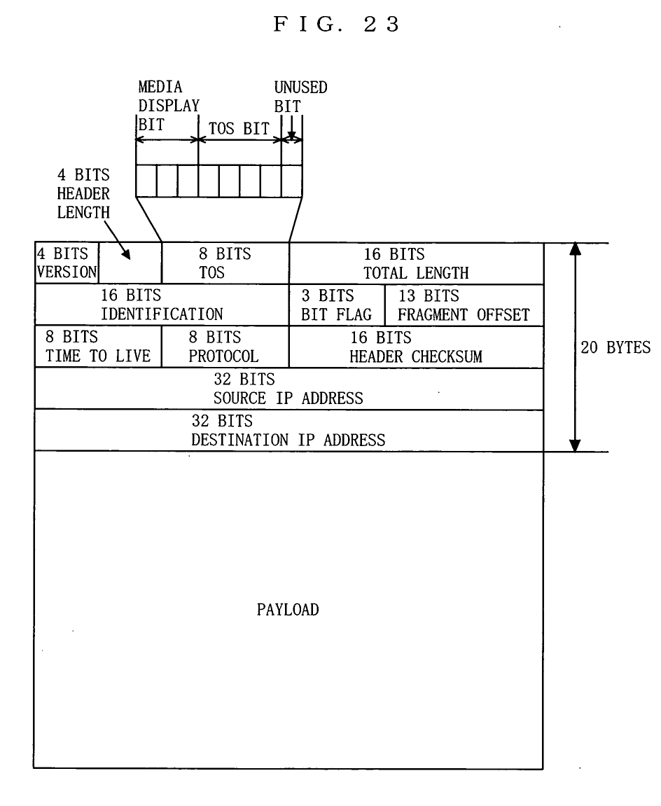

An operation performed by the transfer control section 130 and the radio IF 100 when the radio 100 transfers the transfer data packets to each of the radio communication adaptor 1015₁ to 1015₄ will be described with reference to a drawing. FIG. 22 is a flowchart illustrating the operation performed by the transfer control section 130 when the transfer data packets are transferred to the radio communication adaptors 1015₁ to 1015₄.

Firstly, the transfer control section 130 acquires from the transfer determination section 115 transfer data packets to be transferred to each of the information processing apparatuses 1020₁ to 1020₄ (step S700). Then, the transfer control section 130 buffers the acquired transfer data packets (step S705). In this case, the transfer control section 130 is required to have a function of buffering the transfer data packets.

Next, the transfer control section 130 refers to the bandwidth management table and recognizes respective bandwidths of the acquired transfer data packets (step S710). Thereafter, the transfer control section 130 outputs the buffered transfer data packets to the radio IF 100 on the basis of the recognized bandwidths (step S715). More specifically, the transfer data packets are output to the radio IF 100 so as to be distributed in the time direction at the same ratio as that of the bandwidths recognized at step S710. The radio IF 100 accordingly acquires the transfer data packets and transfers the acquired data packets to each of the radio communication adaptors 1015₁ to 1015₄ in a broadcasting format.

Next, each of the radio communication adaptors 1015₁ to 1015₄, which has received the transfer data packets transferred in the broadcasting format, outputs the received transfer data packets to a corresponding one of the information processing apparatuses 1020₁ to 1020₄. Each of the information processing apparatuses 1020₁ to 1020₄ refers to a MAC address of acquired transfer data packets, and compares the MAC address with its own MAC address. If, for one of the information processing apparatus 1020₁ to 1020₄, both MAC addresses of the acquired transfer data packets and that one information processing apparatus match with each other, that one information processing apparatus determines that the acquired transfer data packets are destined for itself, and stores the acquired transfer data packets. On the other hand, if, for one of the information processing apparatus 1020₁ to 1020₄, both MAC addresses of the acquired transfer data packets and that one information processing apparatus do not match with each other, the one information processing apparatus determines that the acquired transfer data packets are not destined for itself, and discards such transfer data packets. Thus, the operation performed by the transfer control section 130 when the radio IF 100 transfers the transfer data packets to each of the radio communication adaptors 1015₁ to 1015₄ has been described. This operation allows the bandwidth adjusting access point 10 to transfer the transfer data packets in their respective bandwidths allocated by the transfer determination section 115.

As described above, according to the present invention, the bandwidth adjusting access point 10 sets bandwidths of the transfer data packets according to respective required bandwidths set therefor. Therefore, the bandwidth adjusting access point 10 can allocate a broad bandwidth to transfer data packets, such as dynamic image data, which require a broad bandwidth, while allocating a narrow bandwidth to transfer data packets, such as text data, which require a narrow bandwidth. Consequently, the effective bandwidth for the bandwidth adjusting access point 10 can be effectively utilized. Moreover, the dynamic image data is prioritized so as to have a broad bandwidth allocated thereto, and therefore streaming reproduction of the dynamic image data becomes hard to be interrupted.

Further, according to the present invention, the order of transferring the transfer data packets is determined based on priorities set for the transfer data packets. Thus, the bandwidth adjusting access point 10 can realize high-speed transfer to the information processing apparatuses 1015₁ to 1015₄ by prioritizing highly urgent transfer data packets over other transfer data so as to have a broad bandwidth allocated thereto.

In the above-described embodiment, the information processing apparatuses 1015₁ to 1015₄ download the transfer data from the servers 15₁ to 15₄ via the Internet. However, it is also possible to configure the information processing apparatuses 15, to 15₄ so as to download the transfer data via Ethernet.

Also, in the above-described embodiment, as illustrated in FIG. 2, the media identification code is embedded in a payload portion. However, the location in which the media identification code is embedded is not limited to this. For example, the media identification code may be written in TOS (Type Of Service) which is provided in an IP header of a transfer data packet as illustrated in FIG. 23. The TOS includes media display bits and an unused bit which are free regions equivalent to four bits. Accordingly, there are sixteen patterns of media identification codes which can be embedded in the TOS. In the case of writing the media identification code into the TOS, the media identification code is set in a transfer data packet in a network layer simultaneously as setting an IP header.

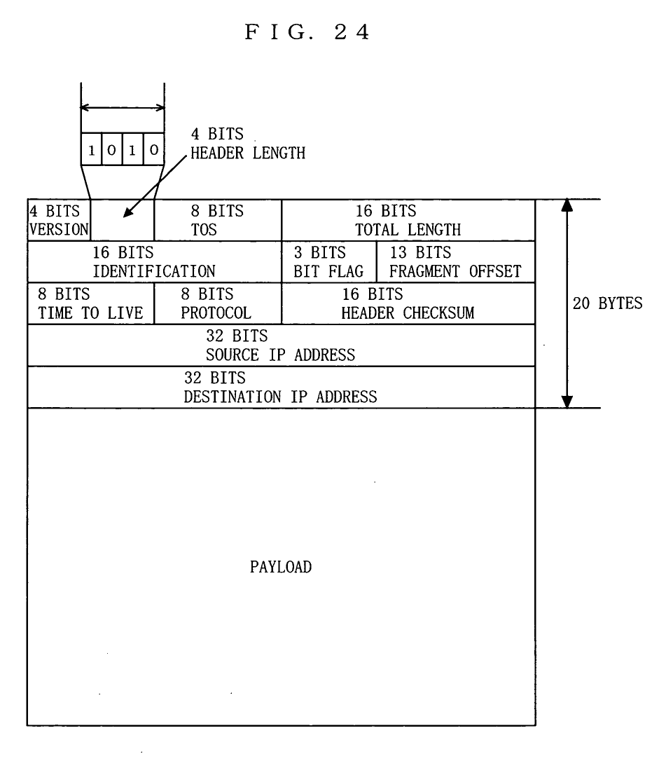

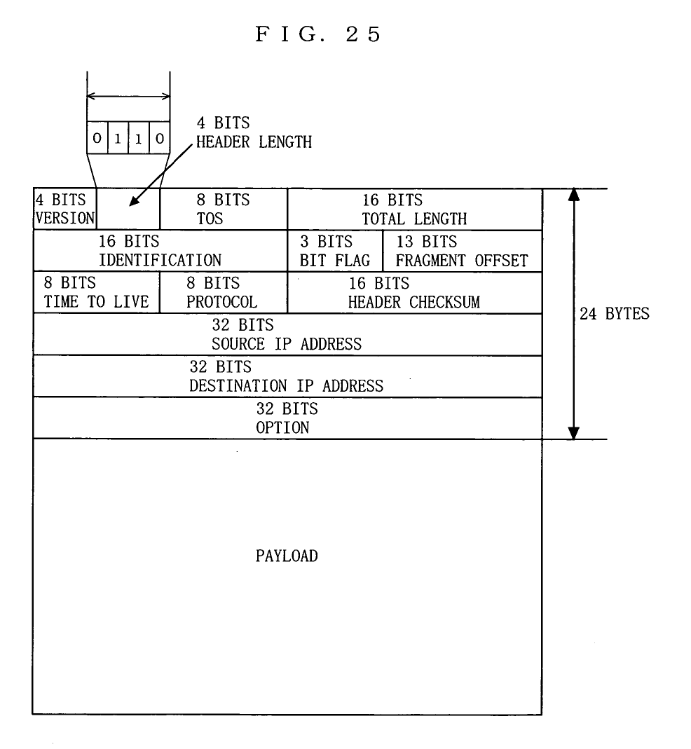

An option field can be set in the IP header by changing setting of a header length setting field within the IP header. More specifically, as illustrated in FIG. 24, the header length setting field is typically set as “1010”. However, by changing the header length setting filed to “0110”, as illustrated in FIG. 25, the option field can be set in the IP header. Thus, the media identification code can be set in the option field.

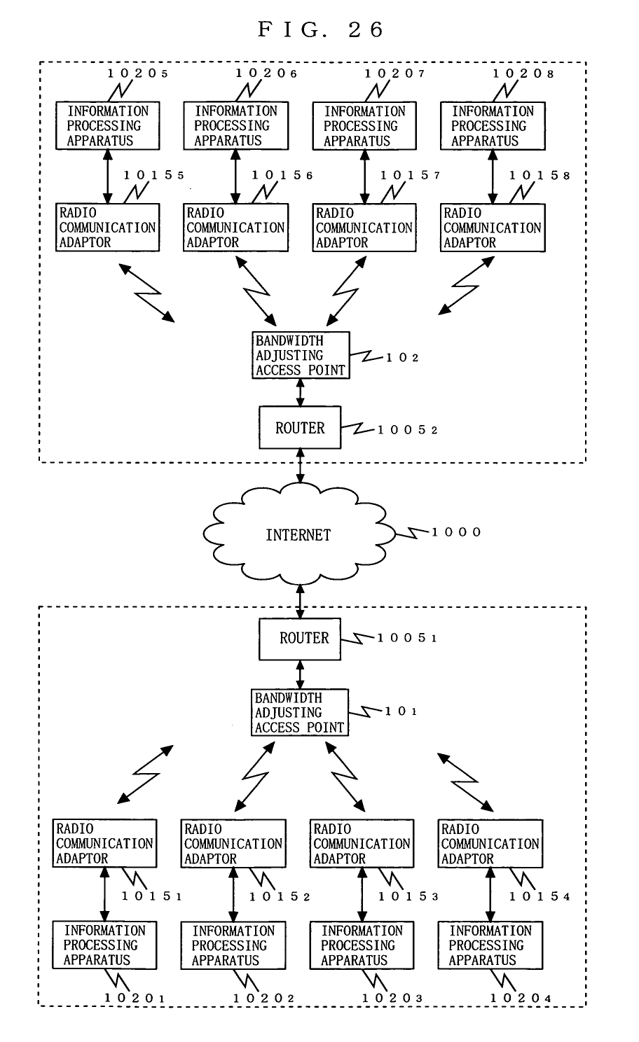

In the network configuration of the above-described embodiment, as illustrated in FIG. 1, the information processing apparatuses 1020₁ to 1020₄ acquire transfer data from the servers 15₁ to 15₄ via the internet 1000. However, the network configuration is not limited to this. In the network configuration of the present invention, as illustrated in FIG. 26, a plurality of LAN systems may be connected to Ethernet or the Internet using a plurality of routers. In such a case, the information processing apparatuses 1015₁ to 1015₄ acquire the transfer data from information processing apparatuses 1020₅ to 1020₈ in another LAN system, rather than from the servers 15₁ to 15₄.

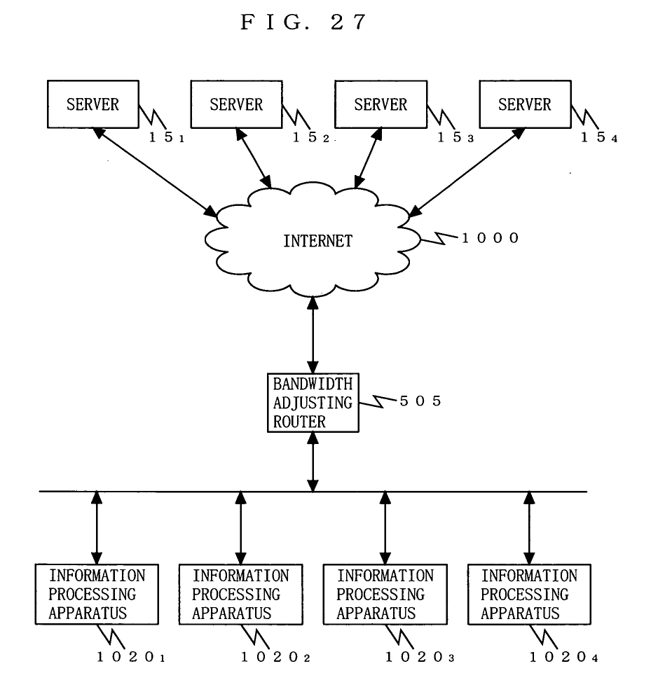

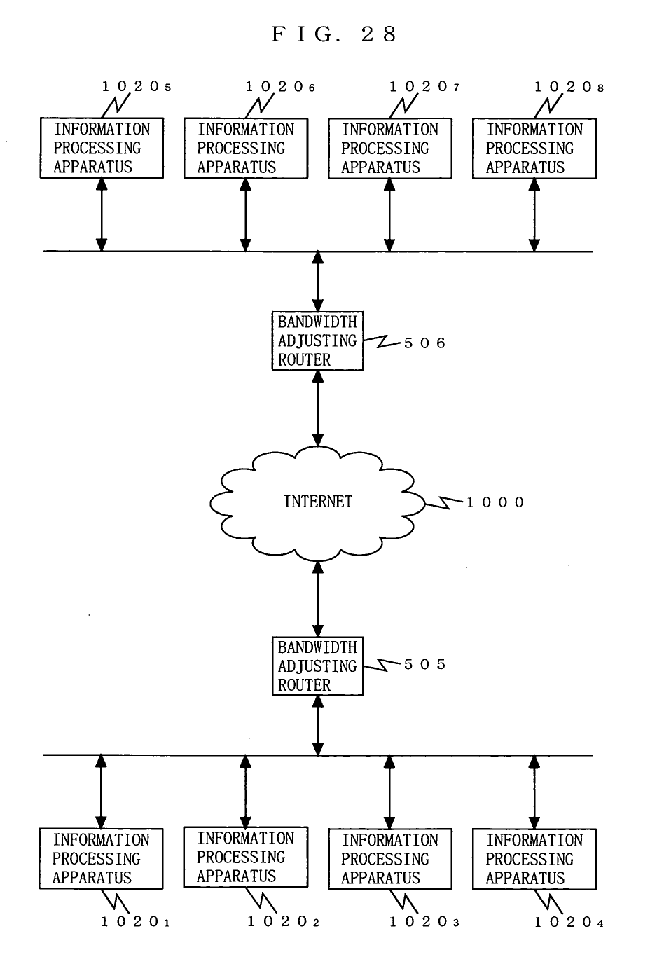

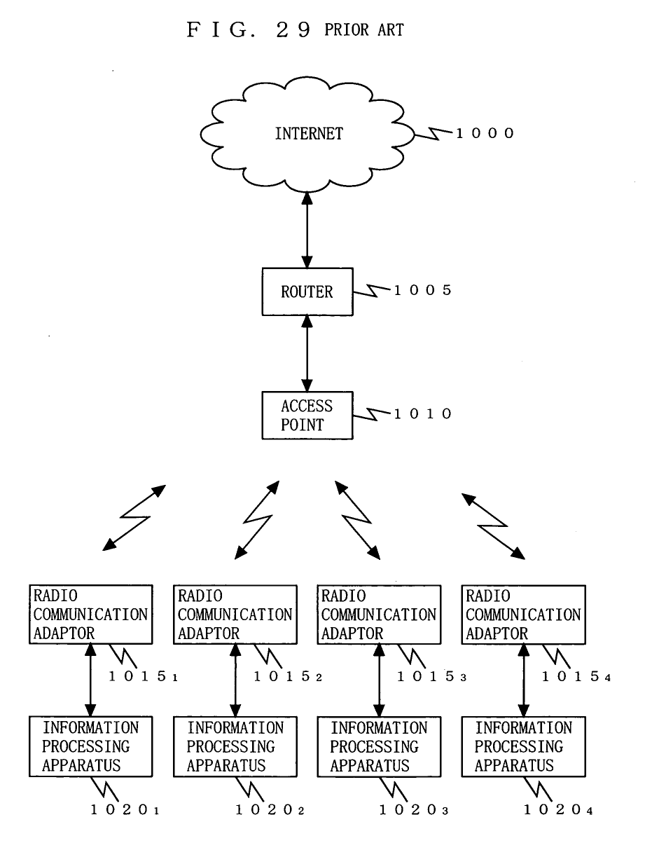

Alternatively, in the network configuration of the present invention, as illustrated in FIG. 27, a wired LAN may be used. In such a case, the request control section 115, the table storage section 120, and the transfer control section 130, which are illustrated in FIG. 8, are included in a bandwidth adjusting router 505. Thus, in the wired LAN, it is possible to adjust bandwidth allocation between the bandwidth adjusting router 505 and each of the information processing apparatuses 1020₁ to 1020₄. In the network configuration of such a case, as illustrated in FIG. 28, a plurality of LAN systems may be connected to Ethernet or the Internet using a plurality of bandwidth adjusting routers 505 and 506.

According to the LAN system of the above-described embodiment, a bandwidth for each transfer data packet is determined based on the priority class information, the required bandwidth information, and the media type information. However, information to be used is not limited to such a combination. For example, the bandwidth for each transfer data packet may be determined based only on the required bandwidth information.

Further, according to the LAN system of the above-described embodiment, the effective bandwidth and the total bandwidth are compared to each other in order to determine whether the transfer data packets can be transferred. However, such a determination is not limitedly made by such comparison. For example, in the case where the bandwidth adjusting access point 10 recognizes an available radio bandwidth, whether the transfer data can be transferred may be determined by comparing the available radio bandwidth and the required bandwidth for the transfer data.

Furthermore, according to the LAN system of the above-described embodiment, as in FIGS. 12, 19, 20, and 21, a bandwidth of transfer data, which is currently being transferred and has a priority lower than or equal to the priority of newly acquired transfer data, is reduced. Alternatively, only a bandwidth of transfer data, which is currently being transferred and has a priority lower than the priority of the newly acquired transfer data, may be reduced.

While the invention has been described in detail, the foregoing description is in all aspects illustrative and not restrictive. It is understood that numerous other modifications and variations can be devised without departing from the scope of the invention.

What is claimed is:

1. A data transmission method for transmitting data from a data transmitter to a LAN system, the data transmitter being connected to the LAN system via a network so as to be allowed to intercommunicate therewith, the method comprising:
an information embedding step for embedding required bandwidth information into the data when the LAN system requests the data transmitter to transmit the data, the required bandwidth information being specific to the data and indicating a bandwidth required for transferring the data; and
a data transmission step for transmitting the data having the required bandwidth information embedded therein to the LAN system via the network,
wherein the LAN system performs a data-by-data determination as to whether bandwidths internally available can be used based on the required bandwidth information embedded in received data.

2. The data transmission method according to claim 1, further comprising:
a data receiving step for the LAN system to receive the data transmitted by the data transmission step;
a bandwidth recognition step for recognizing the bandwidth required for transferring the data based on the required bandwidth information embedded in the data received by the data receiving step;
an occupied bandwidth recognition step for recognizing a bandwidth currently being used among the bandwidths internally available; and
a determination step for determining whether sufficient bandwidth is available to the data received by the data receiving step by comparing the bandwidth required for transferring the data, which is recognized by the bandwidth recognition step, and the bandwidth currently being used, which is recognized by the occupied bandwidth recognition step.

3. The data transmission method according to claim 1, wherein:
the information embedding step embeds priority information, which indicates a priority for allowing the data to use the bandwidths internally available, into the data as well as the required bandwidth information; and
the LAN system performs the data-by-data determination as to whether the bandwidths internally available can be used based on the required bandwidth information and the priority information.

4. The data transmission method according to claim 3, further comprising:
a data receiving step for the LAN system to receive the data transmitted by the data transmission step;
a bandwidth recognition step for recognizing the bandwidth required for transferring the data based on the required bandwidth information embedded in the data received by the data receiving step;
an occupied bandwidth recognition step for recognizing a bandwidth currently being used among the bandwidths internally available;
a priority recognition step for recognizing data-by-data priorities based on the priority information embedded in the data;
a determination step for determining whether sufficient bandwidth is available to the data received by the data receiving step by comparing the bandwidth required for transferring the data, which is recognized by the bandwidth recognition step, and the bandwidth currently being used, which is recognized by the occupied bandwidth recognition step; and
a bandwidth adjusting step for reducing a bandwidth of data, which has a priority lower than that of the data received by the data receiving step among the data-by-data priorities recognized by the priority recognition step, so as to allow the sufficient bandwidth to be available to the data received by the data receiving step when the determination step determines that no sufficient bandwidth is available.

5. The data transmission method according to claim 4, wherein:
the LAN system has a minimum guaranteed bandwidth stored therein, the minimum guaranteed bandwidth indicating minimum bandwidths required for data transfer on a media-type-by-media-type basis of the data;
the information embedding step embeds media type information, which indicates a media type of the data, as well as the required bandwidth information and the priority information;
the priority recognition step further includes a media type recognition step for recognizing a data-by-data media type based on the media type information embedded in the data; and
the bandwidth adjusting step refers to the minimum guaranteed bandwidth stored in the LAN system and reduces the bandwidth of the data to the minimum guaranteed bandwidth corresponding to a media type recognized by the media type recognition step.

6. The data transmission method according to claim 5, wherein the bandwidth adjusting step sequentially reduces a data bandwidth from the lowest to the highest in the order of minimum guaranteed bandwidths.

7. An access relay apparatus for transferring data, which is input by a data transmitter via a network, to a LAN system,
wherein required bandwidth information, which indicates a bandwidth required for transferring the data, is embedded in the data by the data transmitter, and
wherein the access relay apparatus comprises:
a data receiving section for receiving the data transmitted by the data transmitter;
a bandwidth recognition section for recognizing the bandwidth required for transferring the data based on the required bandwidth information embedded in the data received by the data receiving section;
an occupied bandwidth recognition section for recognizing a bandwidth currently being used among bandwidths internally available to the access relay apparatus; and
a determination section for determining whether sufficient bandwidth is available to the data received by the data receiving section by comparing the bandwidth required for transferring the data, which is recognized by the bandwidth recognition section, and the bandwidth currently being used, which is recognized by the occupied bandwidth recognition section.

8. The access relay apparatus according to claim 7,
wherein priority information, which indicates a priority for allowing the data to use the bandwidths internally available, is embedded in the data as well as the required bandwidth information, and
wherein the access relay apparatus comprises:
a priority recognition section for recognizing data-by-data priorities based on the priority information embedded in the data; and
a bandwidth adjusting section for reducing a bandwidth of data, which has a priority lower than that of the data received by the data receiving section among the data-by-data priorities recognized by the priority recognition step, so as to allow the sufficient bandwidth to be available to the data received by the data receiving section when the determination section determines that no sufficient bandwidth is available to the data received by the data receiving section.

9. A data transmitter for transmitting data to a LAN system, the data transmitter being connected to the LAN system via a network so as to be allowed to intercommunicate therewith, the data transmitter comprising:
an information embedding section for embedding required bandwidth information into the data when the LAN system requests the data transmitter to transmit the data, the required bandwidth information being specific to the data and indicating a bandwidth required for transferring the data; and
a data transmission section for transmitting the data having the required bandwidth information embedded therein to the LAN system via the network,
wherein the LAN system performs a data-by-data determination as to whether bandwidths internally available can be used based on the required bandwidth information embedded in received data.

10. The data transmitter according to claim 9, wherein:
the information embedding section embeds priority information, which indicates a priority for allowing the data to use the bandwidths internally available, as well as the required bandwidth information; and
the LAN system performs the data-by-data determination as to whether the bandwidths internally available can be used based on the required bandwidth information and the priority information.
